(19) United States
(12) Patent Application Publication
(10) Pub. No.: US 2011/0032115 A1
(43) Pub. Date: Feb. 10, 2011

(54) Vehicle Having Remote Start and Enclosed Space Detection

(76) Inventors: Robert Kwiecinski, Saline, MI (US); Brian Bennie, Sterling Heights, MI (US); Thomas M. McQuade, Ann Arbor, MI (US); Daniel J. Bartz, Rochester Hills, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/535,213

(22) Filed: Aug. 4, 2009

(51) Int. Cl. G08C 19/00

(52) U.S. Cl. 340/825.69

(57) ABSTRACT

The subject of the present invention is a method for remote starting an internal combustion engine of a vehicle comprising the steps of: detecting a wireless remote start signal; after detecting the wireless remote start signal, activating a parking aid system to detect the presence or absence of a garage door; and if no garage door is detected by the parking aid system, remote starting the internal combustion engine. A carbon monoxide detector or an automatic garage door opener may also be employed in the remote start process.

### BACKGROUND OF THE INVENTION

The present invention relates generally to vehicles having remote start (remote engine start) capabilities, and more particularly to vehicles having remote start capabilities with an ability to detect being parked in an enclosed space.

Vehicle technologies exist that allow for remote starting of vehicles. For example, a key fob may include a button that, when pushed, transmits a signal to the vehicle causing the internal combustion engine to start. Vehicle operators find this feature handy because a heater or air conditioner can be activated with the engine in order to heat or cool the vehicle before the operator enters the vehicle.

One concern with remote start, however, is that the vehicle may be parked in a garage with the garage door closed or other enclosed space when the remote start signal is sent. Moreover, since the remote start button is on a key fob with the vehicle operator, the operator may not realize that the vehicle is in the enclosed space (such as a garage with the door closed) when activating the remote start function. Because internal combustion engines produce exhaust gasses that are undesirable for humans to breathe, it is undesirable for vehicle engines to run while the vehicle is parked in a closed garage or other space where exhaust gasses can build up rather than escape to atmosphere.

### SUMMARY OF THE INVENTION

An embodiment contemplates a method for remote starting an internal combustion engine of a vehicle comprising the steps of: detecting a wireless remote start signal; after detecting the wireless remote start signal, activating a parking aid system to detect the presence or absence of a garage door; and if no garage door is detected by the parking aid system, remote starting the internal combustion engine.

An embodiment contemplates a method for remote starting an internal combustion engine of a vehicle comprising the steps of: detecting a wireless remote start signal; after detecting the wireless remote start signal, activating a parking aid system, including activating a plurality of reverse sensors mounted on a rear of the vehicle, to detect the presence or absence of a garage door; after detecting the wireless remote start signal, detecting a level of carbon monoxide adjacent to the vehicle; and if no garage door is detected by the parking aid system and the detected level of carbon monoxide is below a predetermined level, remote starting the internal combustion engine.

An advantage of an embodiment is the reduced chance that exhaust gasses will build up in an enclosed space due to exhaust emanating from a remotely started vehicle. Moreover, the enclosed space detection can be accomplished by employing sensors that are already mounted on vehicles and used for other purposes, thus minimizing the cost.

### BRIEF DESCRIPTION OF THE DRAWINGS

FIG. 1 shows a schematic, plan view of a vehicle parked in an enclosed structure, such as a garage.

FIG. 2 shows a schematic, side elevation view of the vehicle and enclosure of FIG. 1.

FIG. 3 is a flow chart illustrating a method of remote starting a vehicle that may be parked in an enclosed structure.

FIG. 4 is a schematic view similar to FIG. 1, but illustrating a second embodiment.

FIG. 5 is a schematic view similar to FIG. 2, but illustrating a third embodiment.

### DETAILED DESCRIPTION

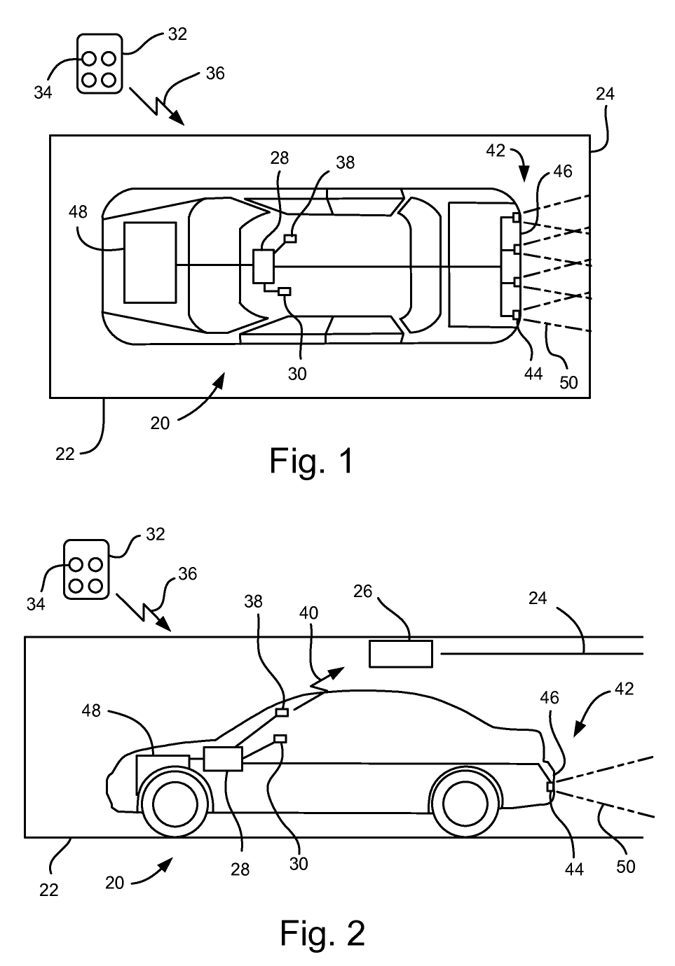

FIGS. 1 and 2 show a vehicle 20 that is parked in an enclosed structure, such as a garage 22, which includes a garage door 24 that is movable between a closed position (shown in FIG. 1) and an open position (shown in FIG. 2) that allows the vehicle 20 to enter/exit the garage 22. The garage 22 may also include a garage door opener 26 (shown in FIG. 2) that that can receive a signal and cause the garage door 24 to open and close.

The vehicle 20 includes a controller 28, which is sometimes called an engine control unit or a powertrain control unit. The controller 28 may made up of various combinations of hardware and software as is known to those skilled in the art. The controller 28 may be in communication with a remote engine start receiver 30 (or transceiver) that receives wireless signals 36 from a key fob 32 having a remote start button 34. The controller 28 may also be in communication with a garage door opener transmitter 38 that can transmit wireless signals 40 to the garage door opener 26 to cause the garage door 24 to open and close. The controller 28 also controls the starting and stopping of an internal combustion engine 48.

The vehicle 20 may also include a parking aid system 42 having reverse sensors 44 mounted at the rear 46 of the vehicle 20 (often in a rear bumper). The reverse sensors 44 detect objects located behind the vehicle 20 (the phantom lines indicating signals 50 from the sensors 44 used to detect objects). The parking aid system 42 is in communication with the controller 28, thus, the detection of objects can be communicated to the controller 28.

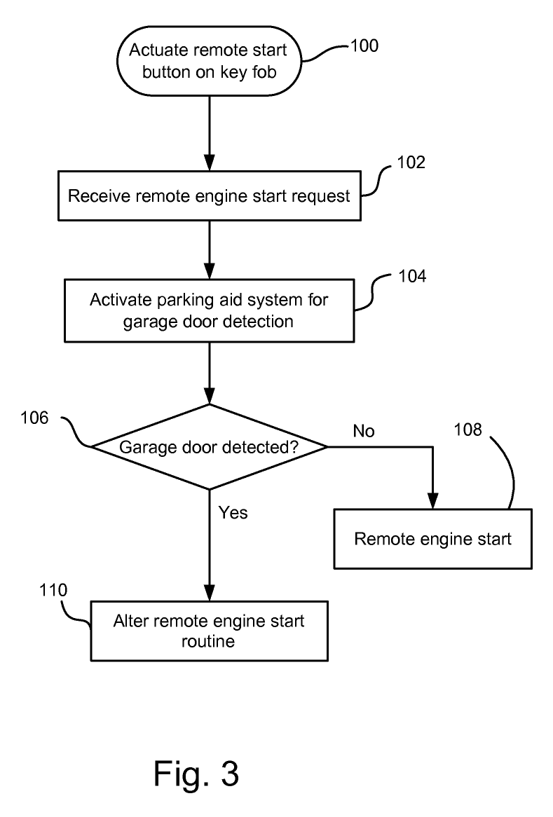

The operation of the vehicle of FIGS. 1 and 2 will now be described with respect to the flow chart of FIG. 3. Upon actuation of the remote start button 34 on the key fob 32, block 100, the remote start signal 36 is transmitted from the fob 32 and, if within range, received by the remote engine start receiver 30 in the vehicle 20. The engine start receiver 30 alerts the controller 28, block 102.

Upon receiving the remote start signal 36, the parking aid system 42 is also activated in a garage door detect mode, block 104. The reverse sensors 44 detect if an object, such as the garage door 24, is behind the vehicle 20 (indicating a closed garage door 24). In order to minimize false detections of a garage door, the parking aid system 42 may recognize the presence of a garage door only if more than one sensor 44 detects an object, or only the information from the middle two sensors 44 may be employed to detect the garage door in order to avoid the side sensors 44 detecting the side of the garage door opening rather than the garage door itself. Alternatively, the parking aid system 42 may employ all four sensors 44, with an object detection by any of them indicating a garage door closed condition.

If the sensors 44 of the parking aid system 42 do not recognize the presence of a garage door, block 106, then the controller 28 will proceed with the remote engine start, block 108. If the presence of a garage door 24 is recognized, block 106, then the controller 28 will alter the remote engine start routine accordingly, block 110. This altering of the remote engine start may take the form of disabling remote engine start. This altering of the remote engine start may also take the form of sending a garage door open signal 40 from the garage door opener transmitter 38 and then remotely starting the engine 48, or sending the garage door open signal 40, employing the parking aid system 42 to re-check for the presence of the garage door 24 and then remotely starting the engine if the presence of the garage door is no longer recognized.

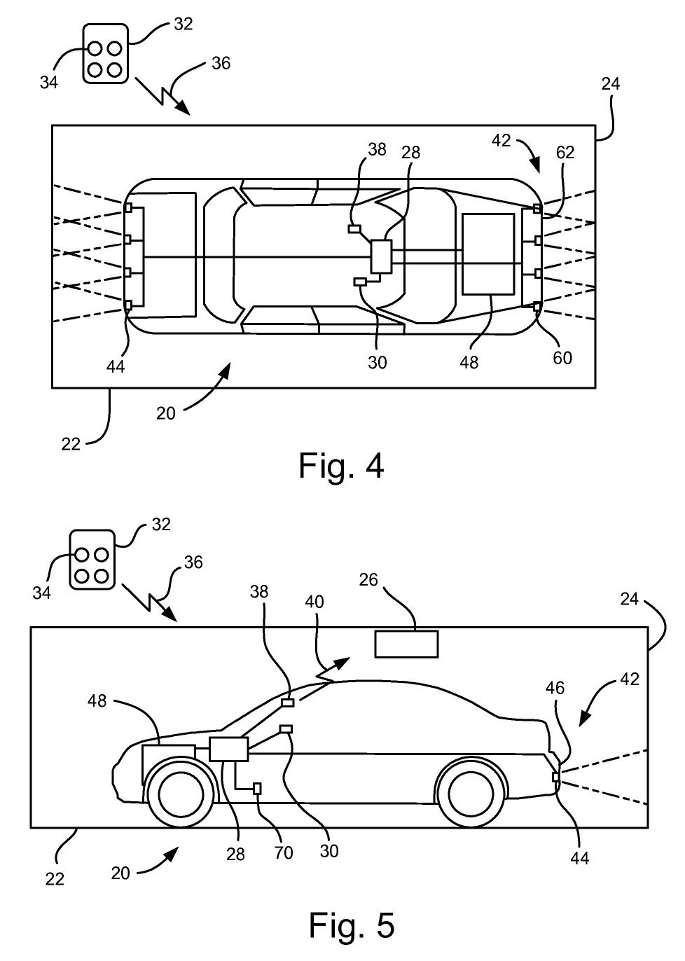

FIG. 4 illustrates a second embodiment of the present invention. Since this embodiment is a modification of the first embodiment, like reference characters designate corresponding elements in the drawings and detailed description thereof will be omitted. In this embodiment, the parking aid system 42 includes forward sensors 60 mounted at the front 62 of the vehicle 20 in addition to the reverse sensors 44.

When a remote start signal 36 is received from the key fob 32, the parking aid system 42 will receive input from both the reverse sensors 44 and the forward sensors 60. If either set of sensors 44, 60 detect that there is no garage door 24 (i.e., there is no object detected at at least one end of the vehicle), then the remote engine start can proceed. If, on the other hand, the reverse and forward sensors 44, 60 both detect structure, such as a garage door 24 and a wall of the enclosed structure 22, then the remote engine start routine is altered.

FIG. 5 illustrates a third embodiment of the present invention. Since this embodiment is a modification of the first embodiment, like reference characters designate corresponding elements in the drawings and detailed description thereof will be omitted. In this embodiment, a carbon monoxide (CO) detector 70 is mounted on the vehicle 20 and in communication with the controller 28.

When a remote start signal 36 is received from the key fob 32, not only is the parking aid system 42 employed to determine if the garage door 24 is opened, but a CO level is determined. The controller 28 proceeds with the remote engine start if both conditions are met. Otherwise the remote engine start routine is altered. If the garage door 24 is detected, the alteration may include, for example, sending a garage door open signal 40 to the garage door opener 26 and then re-checking for the presence of the door 24 and the CO level before determining if remote engine start will be allowed.

In addition, the added features of the second and third embodiments can both be employed on the same vehicle for remote engine start and enclosed space detection.

While certain embodiments of the present invention have been described in detail, those familiar with the art to which this invention relates will recognize various alternative designs and embodiments for practicing the invention as defined by the following claims.

What is claimed is:

1. A method for remote starting an internal combustion engine of a vehicle comprising the steps of:
(a) detecting a wireless remote start signal;
(b) after detecting the wireless remote start signal, activating a parking aid system to detect the presence or absence of a garage door; and
(c) if no garage door is detected by the parking aid system, remote starting the internal combustion engine.

2. The method of claim 1 further comprising the step of:
(d) if a garage door is detected by the parking aid system, disabling the remote engine start.

3. The method of claim 1 further comprising the step of:
(d) if a garage door is detected by the parking aid system, generating a garage door open wireless signal and remote starting the internal combustion engine.

4. The method of claim 1 further comprising the steps of:
(d) if a garage door is detected by the parking aid system, generating a garage door open wireless signal;
(e) after step (d), activating a parking aid system to detect the presence or absence of the garage door; and
(f) if no garage door is detected in step (e), remote starting the internal combustion engine.

5. The method of claim 1 further comprising the step of (d) after detecting the wireless remote start signal, detecting a level of carbon monoxide adjacent to the vehicle; and
wherein step (c) is further defined by remote starting the internal combustion engine if both no garage door is detected by the parking aid system and the level of carbon monoxide detected is below a predetermined limit.

6. The method of claim 1 wherein step (b) is further defined by the activation of the parking aid system including activating a plurality of reverse sensors mounted on a rear of the vehicle to detect an object behind the vehicle.

7. The method of claim 6 wherein step (b) is further defined by the activation of the parking aid system including activating a plurality of forward sensors mounted on a front of the vehicle to detect an object in front of the vehicle.

8. A method for remote starting an internal combustion engine of a vehicle comprising the steps of:
(a) detecting a wireless remote start signal;
(b) after detecting the wireless remote start signal, activating a parking aid system, including activating a plurality of reverse sensors mounted on a rear of the vehicle, to detect the presence or absence of a garage door;
(c) after detecting the wireless remote start signal, detecting a level of carbon monoxide adjacent to the vehicle; and
(d) if no garage door is detected by the parking aid system and the detected level of carbon monoxide is below a predetermined level, remote starting the internal combustion engine.

9. The method of claim 8 further comprising the step of:
(e) if a garage door is detected by the parking aid system, disabling the remote engine start.

10. The method of claim 8 further comprising the step of:
(e) if a garage door is detected by the parking aid system, generating a garage door open wireless signal and remote starting the internal combustion engine.

11. The method of claim 8 further comprising the steps of:
(e) if a garage door is detected by the parking aid system, generating a garage door open wireless signal;
(f) after step (e), activating a parking aid system to detect the presence or absence of the garage door; and
(g) if not garage door is detected in step (f), remote starting the internal combustion engine.

12. The method of claim 8 wherein step (b) is further defined by the activation of the parking aid system including activating a plurality of forward sensors mounted on a front of the vehicle to detect an object in front of the vehicle, and a detection of no garage door is achieved if either the plurality of reverse sensors or the plurality of forward sensors or both detect no object indicative of the garage door.
